(19) United States
(12) Patent Application Publication
(10) Pub. No.: US 2003/0123786 A1
(43) Pub. Date: Jul. 3, 2003

(54) Optical switch

(75) Inventor: Young Joo Yee, Kyonggi-do (KR)

Correspondence Address: FLESHNER & KIM, LLP, P.O. Box 221200, Chantilly, VA, 20153-1200, US

(73) Assignee: LG Electronics Inc.

(21) Appl. No.: 10/328,137

(22) Filed: Dec. 26, 2002

(30) Foreign Application Priority Data
Dec. 29, 2001 (KR) P 2001-87755

(51) Int. Cl. G02B 6/35; G02B 6/34

(52) U.S. Cl. 385/16; 385/36

(57) ABSTRACT

Disclosed is an optical switch enabling to be advantageous in cost, performance, size, weight, and fabricating process as well as carry out a switching function with a low driving voltage. The present invention includes a substrate, an input optical fiber over the substrate for incidence of an optical signal, at least one output optical fiber over the substrate for projection of the optical signal, and a micro-prism over the substrate for switching a projection path of the optical signal incident on the input optical fiber.

This application claims the benefit of the Korean Application No. P2001-B7755 filed on Dec. 29, 2001, which is hereby incorporated by reference.

### BACKGROUND OF THE INVENTION

1. Field of the Invention

The present invention relates to an optical switch, and more particularly, to an optical switch using a micro-prism.

2. Discussion of the Related Art

Generally, previous communication networks transmitting/receiving electrical signals thorough transmission lines made of copper use integrated circuits on which logic circuits, amplifiers; switches, and the like are integrated, thereby enabling to provide an inexpensive data interface connecting a subscriber side to a system side.

On the other hand, in case of an optical communication network transmitting optical signals through a transmission line made of an optical fiber, it is expensive to set up a data interface for connection between a subscriber side and a system side. This is because the optical fiber itself is expensive as well as the data interface for optical communication includes elements of optical fibers instead of a logic integrated circuit. Besides, as the optical communication data interface is constructed with an optic connector, optical switches, an optical transmitter including a laser diode, and the like, theses elements are manufactured by precision process or component assembly to make the optical communication data interface expensive as well as directly increase the cost for establishing the optical communication network.

As a core component of the optical communication data interface, the optical switch is applied to a backbone network for which high-speed transmission and reliance of information transmission are especially important. Specifically, in case of FDDI (fiber distributed data interface) according to the ANSI X3T9.5 standard proposed for the usage of the backbone networks since a network side has to transmit an optical signal continuously even if a reception path of a subscriber terminal is cut off, a transmission path of the network side should not be cut off even if the subscriber terminal fails to receive the optical signal. For this, the network side requires an optical switch as a bypass switch enabling to carry out a loop-back function.

However, the optical switch according to a related art carries out a switching function by a mechanical drive, thereby having difficulty in having a small size as well as needing too much power consumption. Moreover, the optical switch according to the related art is as expensive as other components of the optical communication data interface.

### SUMMARY OF THE INVENTION

Accordingly, the present invention is directed to an optical switch that substantially obviates one or more problems due to limitations and disadvantages of the related art.

An object of the present invention is to provide an optical switch enabling to be advantageous in cost, performance, size, weight, and fabricating process as well as carry out a switching function with a low driving voltage.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an optical switch according to the present invention includes a substrate, an input optical fiber over the substrate for incidence of an optical signal, at least one output optical fiber over the substrate for projection of the optical signal, and a micro-prism over the substrate for switching a projection path of the optical signal incident on the input optical fiber.

Preferably, the optical switch further includes grooves over the substrate to sit the optical fibers thereon, respectively.

Preferably, each of the grooves is formed by a pair of sit supporters protruding from the substrate to have an interval smaller than a caliber of the corresponding optical fiber.

Preferably, the grooves are formed by microstructures protruding from the substrate to align axes of the optical fibers to the micro-prism within an allowable error limit when the optical fibers are assembled to the optical switch.

Preferably, the optical switch further includes a cantilever having a fixed end attached to the substrate and a free end released from the fixed end to suspend over the substrate.

More preferably, the micro-prism is integrated on one side of the free end of the cantilever.

More preferably, the optical switch further includes a thin film actuator on the cantilever to displace the free end having the micro-prism attached thereto so that the micro-prism is displaced in a direction vertical to the substrate.

More preferably, the optical switch further includes a plurality of electrode pads integrated on the thin film actuator to have the free end of the cantilever displaced in the direction vertical to the substrate.

More preferably, the micro-prism identically displaced as the free end of the cantilever is displaced in the direction vertical to the substrate when a power is applied to the electrode pads.

More preferably, the free end having the micro-prism attached thereto is displaced by a piezo-electric driving to displace the micro-prism in the direction vertical to the substrate.

More preferably, the piezo-electric driving is generated by piezoelectricity of a PZT (Pb—Zr—Ti) or ZnO oxide thin film.

More preferably, the free end having the micro-prism attached thereto is displaced by an electro-thermal driving to displace the micro-prism in the direction vertical to the substrate.

More preferably, the electro-thermal driving is achieved by stacking a plurality of thin film metal layers having bimetal structures and by displacing the stacked thin film metal layers by heat generated from electricity.

More preferably, the free end having the micro-prism attached thereto is displaced by an electromagnetic driving to displace the micro-prism in the direction vertical to the substrate.

More preferably, the electromagnetic driving displaces the free end by a reaction of a magnetic material to electromagnetism.

More preferably, a release interval of the free end from the substrate is equal to a thickness of a sacrificial layer formed temporarily on the substrate.

More preferably, a release interval of the free end from the substrate is formed by deposition of bulk micromachining and etch.

Preferably, the micro-prism has a mirror face vertical to the substrate for total reflection of the optical signal incident on the input optical fiber.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a bird's-eye view of an optical switch according to the present invention;

FIG. 2 illustrates a top layout an optical switch according to the present invention;

FIG. 3 illustrates a cross-sectional view of the optical switch in FIG. 2 along a cutting line A-B;

FIG. 4A and FIG. 4B illustrate cross-sectional views of an optical switch according to the present invention for explaining a drive of the optical switch and a variation of a light path; and

FIGS. 5A to 5I illustrate cross-sectional views of fabricating an optical switch according to the present invention.

### DETAILED DESCRIPTION OF THE INVENTION

Reference will now be made in detail to the preferred embodiments of the present invention, examples of which are illustrated in the accompanying drawings Wherever possible, the same reference numbers will be used throughout the drawings to refer to the same or like parts.

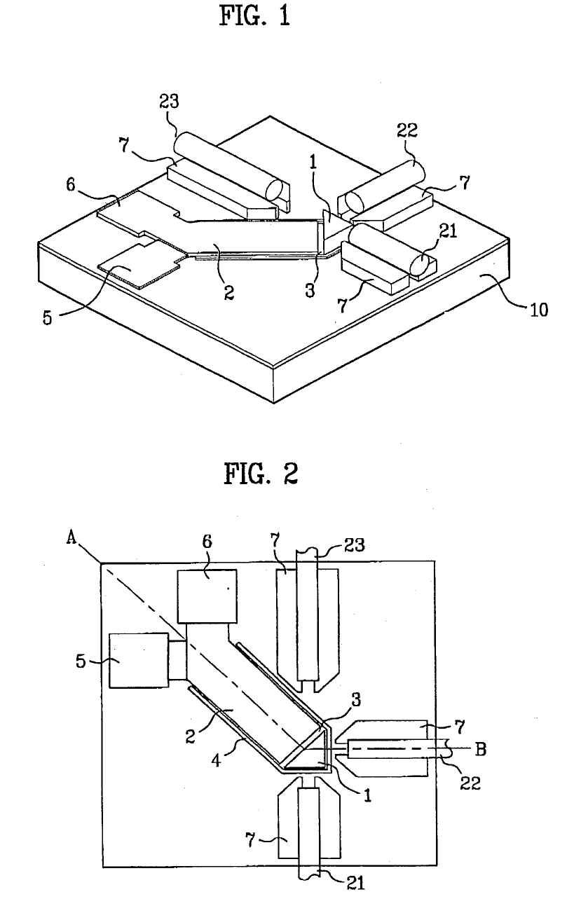

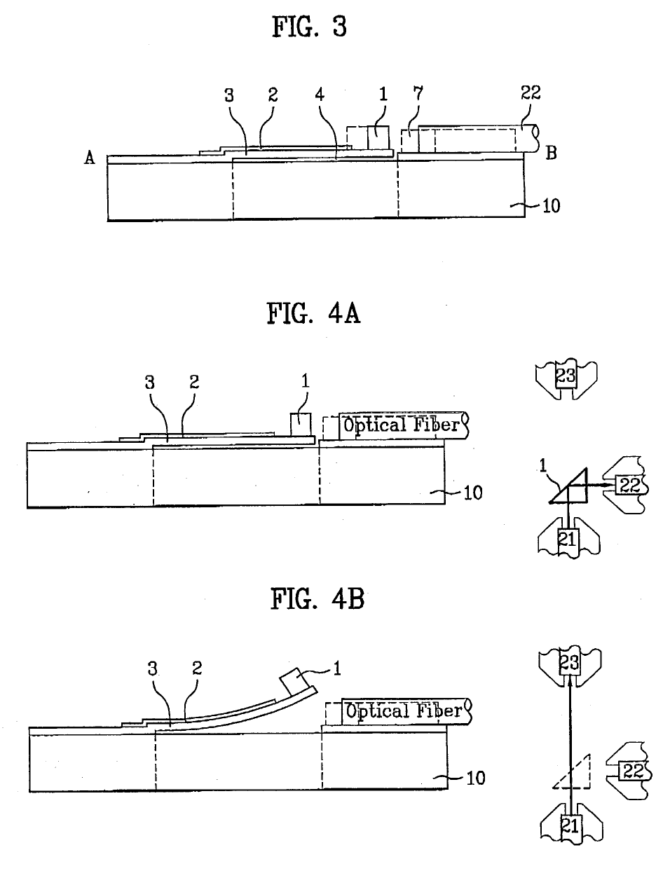

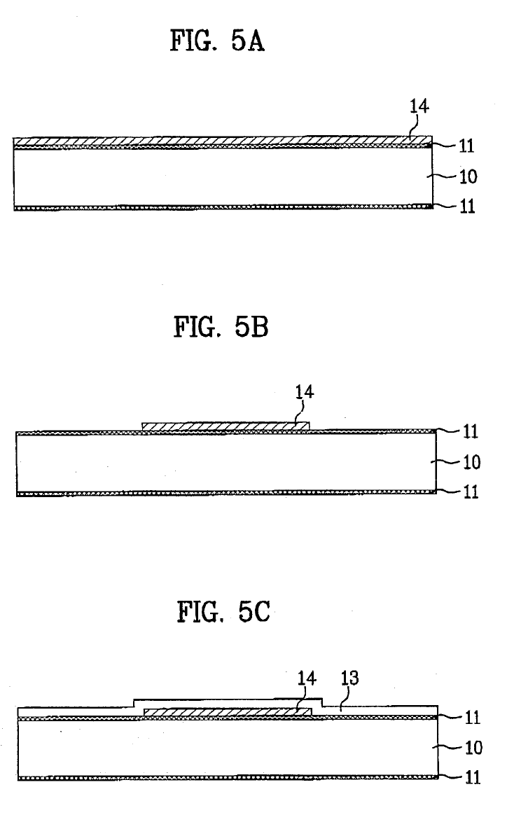

FIG. 1 illustrates a bird's-eye view of an optical switch according to the present invention, FIG. 2 illustrates a top layout an optical switch according to the present invention, and FIG. 3 illustrates a cross-sectional view of the optical switch in FIG. 2 along a cutting line A-B.

Referring to FIGS. I to 3, an optical switch according to the present invention includes a micro-prism 1, a thin film actuator 2, a cantilever 3, electrode pads 5 and 6, sit supporters 7, a substrate 10, and optical fibers 21 to 23.

The micro-prism 1 is formed on a portion of a free end of the cantilever 3 on the substrate 10, and totally reflects an optical signal incident on the input optical fiber 21 to switch an outgoing path. For comparison, an optical switch according to the related art reflects an optical signal through a metal mirror face to carry out a switching function. Hence, a process for forming the metal mirror face is essential for the related art fabrication method Instead, the present invention uses the micro-prism 1 enabling to bring about internal total reflection. For instance, in case that a couple of output optical fibers 22 and 23 are used for the input optical fiber 21, i.e., in case that the output optical fiber 23 on a straight line from the input optical fiber 21 and the other output optical fiber 22 perpendicular to the input optical fiber 21, as shown in FIG. 1, are used, the optical switch according to the present invention uses the 45° micro-prism 1 to switch the incident optical signal to the latter output optical fiber 22.

Specifically, the micro-prism 1 is assembled so that a mirror face bringing about internal total reflection of the incident optical signal is vertical to the substrate 10.

The cantilever 3 includes a fixed end attached to the substrate 10 and the free end separated to leave a predetermined gap (a release interval of the free end from the substrate) from the substrate 10. In this case, the free end is released from the fixed end to suspend from a top of the substrate 10, thereby being separated from the substrate 10 with the predetermined gap 4. In a process of fabricating the optical switch, the gap 4 is generated between the free end and the substrate to the thickness of a sacrificing layer formed temporarily by surface micromachining on the substrate 10.

Instead, the gap 4 between the substrate 10 and the free end can be formed by etch after a film is deposited by bulk micromachining.

The micro-prism 1 is attached on the cantilever 3 to be integrated on one side of the free end, and more specifically, on a tip of the free end.

The free end having the micro-prism 1 attached on the tip is displaced upward and downward by the thin film actuator 2. The object of displacing the free end is to provide upward and downward displacement of the micro-prism 1 substantially. Hence, the displacement of the free end of the cantilever 3 means that the micro-prism 1 is displaced.

The thin film actuator 2 is integrated across portions of the fixed and free ends of the cantilever 3, and an exact location of the thin film actuator 2 is adjusted to be suitable for characteristics of the optical switch in the actual fabrication process.

The thin film actuator 2 integrated on the cantilever 3 displaces the free end having the micro-prism 1 attached thereto in a direction vertical to the substrate 10. This is for displacing the micro-prism 1 in the direction vertical to the substrate 10.

Specifically, a plurality of the electrode pads 5 and 6 are integrated on the thin film actuator 2 for the displacement of the free end of the cantilever 3. Hence, once a power is applied through the electrode pads 5 and 6, the free end of the cantilever 3 is displaced in the vertical direction. It is of course that the micro-prism 1 is displaced in accordance with the displacement of the free end. When the micro-prism 1 is displaced, the incident optical signal is projected to the output optical fiber 23 disposed on the straight line to the input optical fiber 21.

The thin film actuator 2 is driven by the power applied to the electrode pads 5 and 6 piezo-electrically, electric-thermally, or electromagnetically.

When the thin film actuator 2 is driven piezo-electrically, a PZT (Pb—Zr—Ti oxide) or ZnO (zinc oxide) film is used. And, the piezo-electric driving by piezoelectricity of the oxide displaces the free end (and micro-prism) in the direction vertical to the substrate 10.

When the thin film actuator 2 is electric-thermally driven, bimetal-like thin metal films arranged plurally are used. And, heat generated by the power applied through the electrode pads 5 and 6 displaces the arranged thin metal films to displace the free end (and micro-prism) in the direction vertical to the substrate 10.

When the thin film actuator 2 is electro-magnetically driven, the free end is displaced by the reaction to electromagnetism of a magnetic material.

Three pairs of the sit supporters 7 protrude from the top of the substrate 10. Each of the pairs of the sit supporters 7 has a groove. And, each of the optical fibers 21, 22, and 23 is supported by the corresponding groove. Besides, an interval between the sit supporters 7 constructing each of the three pairs on the substrate 10 is smaller than each caliber of the optical fibers 21, 22, and 23.

When the output optical fiber 23 disposed on the straight line to the input optical fiber 21 and the other output optical fiber 22 perpendicular to the input optical fiber 21, as shown in FIG. 2, are simultaneously used, three pairs of the sit supporters 7 are formed to assemble cross-like centering around the micro-prism 1.

Specifically, when the optical fibers 21, 22, and 23 are assembled to the optical switch, the grooves are formed to align axes of the optical fibers 21, 22, and 23 to the micro-prism 1 within an allowable error range.

This is because the performance of the optical switch greatly depends on the precision of optically axial alignment between the micro-prism 1 and the optical fibers 21, 22, and 23.

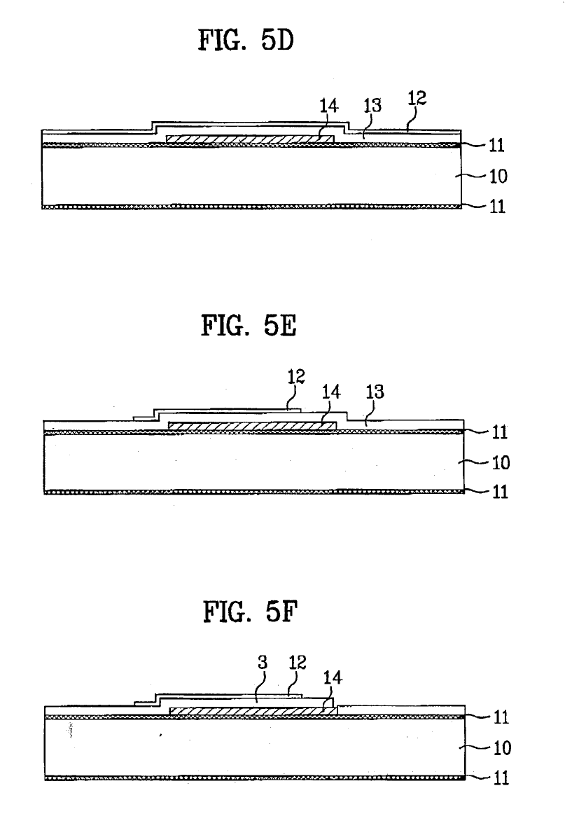

FIG. 4A and FIG. 4B illustrate cross-sectional views of an optical switch according to the present invention for explaining a drive of the optical switch and a variation of a light path.

FIG. 4A shows that a power is not applied to the thin film actuator 2 through the electrode pads 5 and 6.

Referring to FIG. 4A, the micro-prism 1 is disposed on an optical path projected from the collimated input optical fiber 21. And, an optical signal outputted from the input optical fiber 21 is reflected on the mirror face of the micro-prism 1, thereby being switched to the output optical fiber 22 lying in a direction vertical to the input optical fiber 21.

FIG. 4B shows that a power is applied to the thin film actuator 2 through the electrode pads 5 and 6.

Referring to FIG. 4B, the micro-prism 1 deviates from the optical path projected from the collimated input optical, fiber 21, and is displaced in the direction vertical to the substrate 10. Hence, the optical signal outputted from the input optical fiber 21 fails to pass the micro-prism 1 but is incident on the output optical fiber 23 disposed on the straight line to the input optical fiber 21.

Meanwhile, a process of fabricating an optical switch according to the present invention is explained as follows.

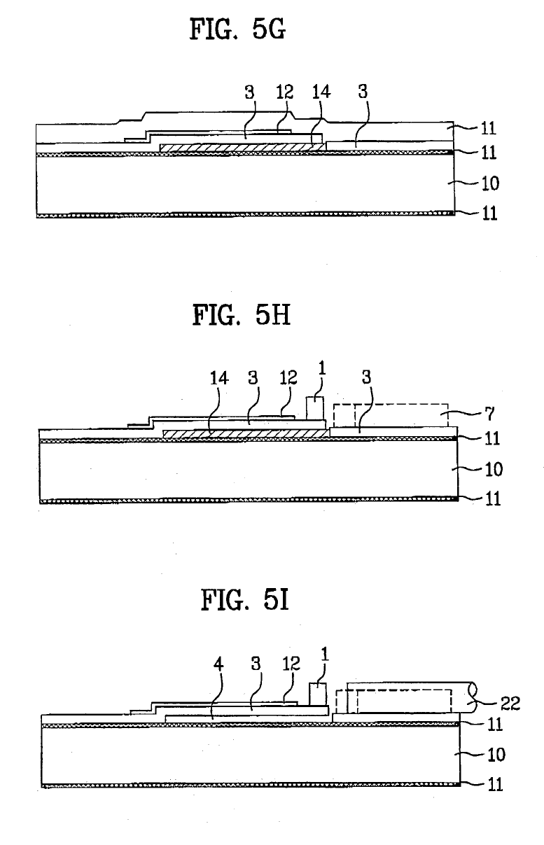

FIGS. 5A to 5I illustrate cross-sectional views of fabricating an optical switch according to the present invention, in which the optical switch is piezo-electrically driven.

Referring to FIG. 5A, silicon oxide layers 11 are formed on a top and a bottom of a substrate 10, respectively. In this case, the silicon oxide layers 11 are formed by oxidation or deposition.

And, a sacrificial layer 14 that will be removed later is formed to have a predetermined thickness on the silicon oxide layer 11 onto the top of the silicon-based substrate 10. In this case, the thickness of the sacrificial layer 14 determines a size of a gap 4 between the substrate 10 and a free end of a cantilever 3. Besides, the sacrificial layer 14 is formed by depositing a silicon film having an amorphous or polycrystalline characteristic over the entire top of the substrate 10.

Referring to FIG. 5B, the sacrificial layer 14 formed on the substrate 10 is patterned. Specifically, a portion of the sacrificial layer 14 except the other portion that will remain beneath the free end of the cantilever 3. In this case, the sacrificial layer 14 is removed in part by photolithography or etch. Preferably, the etch is RIE (reactive ion etch), plasma etch, or chemical wet etch.

Referring to FIG. 5C, a first thin film 13 is deposited on the patterned sacrificial layer 14 and the exposed silicon oxide layer 11 on the top of the substrate 10. The first thin film 13 is deposited for the formation of the cantilever 3 with a material having a minimum residual stress and a minimum stress gradient. The reason why the thin film having the minimum residual stress and stress gradient is to prevent deformation of the cantilever 3.

Referring to FIG. 5D, a second thin film 12 is deposited on the first thin film 13. The second thin film 12 is deposited for the formation of a thin film actuator 2 that will be attached to the cantilever 3. In this case, the second thin film 12 is formed by deposition or coating.

Referring to FIG. 5E, a portion of the second thin film 12 except the other portion corresponding to a shape of the thin film actuator 2 is removed to form the thin film actuator 2.

Referring to FIG. 5F, a portion of the first thin film 13 except the other portion corresponding to the shape of the cantilever 3 and an area that will become a base of a sit supporter 7 is removed to form the cantilever 3.

In the steps of FIG. 5E and FIG. 5F, the first and second thin films 13 and 14 are removed by photolithography or etch.

Referring to FIG. 5G, a third thin film 13 is formed to have a predetermined thickness over the entire top of the substrate 10 having the thin film actuator 2 and cantilever 3 formed thereon. In this case, the third thin film 11 is formed of transparent photosensitive polymer or photoresist to the predetermined thickness.

Although not shown in the drawing, areas corresponding to a shape of a micro-prism 1 and a shape of the sit supporter 7 are patterned by photolithography. In this case, the third thin film 11 is patterned so that three pairs of the sit supporters 7 are formed to make a cross shape centering around the micro-prism 1.

Referring to FIG. 5H, the micro-prism 1 is assembled on one side of the cantilever 3 as well as the sit supporters 7 are assembled on a sit supporter base.

Specifically, the micro-prism 1 is assembled on the one side of the cantilever 3 in a manner that a mirror face of the micro-prism 1 is vertical to the substrate 10, and the sit supporters 7 are assembled on the base formed of the first thin film 13 to make three pairs. As the pairs of the sit supporters 5 are assembled thereon, a groove is generated between each of the pairs of the sit supporters 7. The grooves form a cross shape centering around the micro-prism 1 to hold an input optical fiber 21 for an incident optical signal and output optical fibers 22 and 23 for outputting the optical signal, respectively.

Referring to FIG. 5I, the sacrificial layer 14 remaining between the free end of the cantilever 3 and the substrate 10 to separate a portion of the cantilever 3 from the substrate 10.

Thereafter, the input optical fiber 21 for an incident optical signal and the output optical fibers 22 and 23 for outputting the optical signal are assembled to the grooves of the assembled pairs of the sit supporters 7. And, a pair of electrode pads 5 and 6 are integrated on a partial surface of the thin film actuator 2 formed of the second thin film 12.

Accordingly, the present invention implements the optical switch as a major component of a transmission/reception module interface for optical communication by micromachining and a semiconductor process, thereby enabling to realize such features as small size and lightweight. Therefore, the present invention enables to reduce a component cost as well as lower a driving voltage for switching greatly.

The optical switch according to the present invention is applicable to a bypass switch for FDDI (fiber distributed data interface).

Moreover, the optical switch according to the present invention enables to implement an extended n*n optical matrix switch with ease when being used as the bypass switch for FDDI.

Besides, the related art optical switch requires the process of forming the metal mirror face necessary for switching an optical signal. Yet, the optical switch according to the present invention uses the micro-prism for switching an optical signal, thereby requiring no additional process of forming the metal mirror face. Therefore, the present invention enables to fabricate the device with a reduced product cost.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An optical switch comprising:
a substrate;
an input optical fiber over the substrate for incidence of an optical signal;
at least one output optical fiber over the substrate for projection of the optical signal; and
a micro-prism over the substrate for switching a projection path of the optical signal incident on the input optical fiber.

2. The optical switch of claim 1, further comprising grooves over the substrate to sit the optical fibers thereon, respectively.

3. The optical switch of claim 1, wherein each of the grooves is formed by a pair of sit supporters protruding from the substrate to have an interval smaller than a caliber of the corresponding optical fiber.

4. The optical switch of claim 1, wherein the grooves are formed by micro-structures protruding from the substrate to align axes of the optical fibers to the micro-prism within an allowable error limit when the optical fibers are assembled to the optical switch.

5. The optical switch of claim 1, further comprising a cantilever having a fixed end attached to the substrate and a free end released from the fixed end to suspend over the substrate.

6. The optical switch of claim 5, wherein the micro-prism is integrated on one side of the free end of the cantilever.

7. The optical switch of claim 5, further comprising a thin film actuator on the cantilever to displace the free end having the micro-prism attached thereto so that the micro-prism is displaced in a direction vertical to the substrate.

8. The optical switch of claim 7, further comprising a plurality of electrode pads integrated on the thin film actuator to have the free end of the cantilever displaced in the direction vertical to the substrate.

9. The optical switch of claim 8, wherein the micro-prism is identically displaced as the free end of the cantilever is displaced in the direction vertical to the substrate when a power is applied to the electrode pads.

10. The optical switch of claim 7, wherein the free end having the micro-prism attached thereto is displaced by a piezo-electric driving to displace the micro-prism in the direction vertical to the substrate.

11. The optical switch of claim 10, wherein the piezo-electric driving is generated by piezoelectricity of a PZT (Pb—Zr—Ti) or ZnO oxide thin film.

12. The optical switch of claim 7, wherein the free end having the micro-prism attached thereto is displaced by an electro-thermal driving to displace the micro-prism in the direction vertical to the substrate.

13. The optical switch of claim 12, wherein the electro-thermal driving is achieved by stacking a plurality of thin film metal layers having bimetal structures and by displacing the stacked thin film metal layers by heat generated from electricity.

14. The optical switch of claim 7, wherein the free end having the micro-prism attached thereto is displaced by an electro-magnetic driving to displace the micro-prism in the direction vertical to the substrate.

15. The optical switch of claim 14, wherein the electro-magnetic driving displaces the free end by a reaction of a magnetic material to electromagnetism.

16. The optical switch of claim 5, wherein a release interval of the free end from the substrate is equal to a thickness of a sacrificial layer formed temporarily on the substrate.

17. The optical switch of claim 5, wherein a release interval of the free end from the substrate is formed by deposition of bulk micromachining and etch.

18. The optical switch of claim 1, wherein the micro-prism has a mirror face vertical to the substrate for total reflection of the optical signal incident on the input optical fiber.
